(19) United States
(12) Patent Application Publication
(10) Pub. No.: US 2025/0178047 A1
(43) Pub. Date: Jun. 5, 2025

(54) COFFEE WASTE PRODUCTS AND USES THEREOF

(71) Applicant: THE STATE OF ISRAEL, MINISTRY OF AGRICULTURE & RURAL DEVELOPMENT, AGRICULTURAL RESEARCH ORGANIZTION, Rishon Lezion (IL)

(72) Inventors: Roy Posmanik, Kibbutz Ramat David (IL); Ellen Ruth Graber, Rehovot (IL); Maya Bar, Ramat-Gan (IL)

(21) Appl. No.: 18/840,691

(22) PCT Filed: Feb. 22, 2023
(86) PCT No.: PCT/IL2023/050184

§ 371 Date: Aug. 22, 2024

Related U.S. Application Data
(60) Provisional application No. 63/313,557, filed on Feb. 24, 2022.

(51) Int. Cl. B09B 3/80; A01N 65/08; B09B 3/40; B09B 101/70

(52) U.S. Cl. CPC B09B 3/80; A01N 65/08; B09B 3/40; B09B 2101/70

(57) ABSTRACT

The present disclosure provides a method for processing coffee waste, the method comprises (i) subjecting an aqueous mixture comprising particulated coffee waste and an aqueous medium to hydrothermal conditions, to obtain a coffee waste slurry including particulates; and (ii) separating at least part of the particulates from said coffee waste slurry, to obtain a coffee waste product; wherein, said hydrothermal conditions comprise a temperature above 170° C.; and a pressure equal or above 1 MPa. Further provided by the present disclosure is a coffee waste product comprising in an aqueous sample volume of 1 liter any one or combination of the following characteristics: total antioxidant capacity from about 6000 and about 8000 mg Fe(II) eq., total phenolic content from about 2000 and about 3000 mg gallic acid (GA) eq., and total furfural compounds content from about 1000 ppm and 2000 ppm. Finally, the presently disclosed subject matter provides a method comprising applying to a plant or a plant soil an amount of disclosed coffee waste product.

### TECHNOLOGICAL FIELD

The present disclosure relates to processing of coffee waste.

### BACKGROUND ART

References considered to be relevant as background to the presently disclosed subject matter are listed below:
[1] Ballesteros, L. F., Ramirez, M. J., Orrego, C. E., Teixeira, J. A., Mussatto, S. I. 2017. Optimization of autohydrolysis conditions to extract antioxidant phenolic compounds from spent coffee grounds, J. Food Eng. 199, 1-8.
[2] Arauzo, P. J., Lucian, M., Du, L., Olszewski, M. P., Fiori, L., Kruse, A., 2020. Improving the recovery of phenolic compounds from spent coffee grounds by using hydrothermal delignification coupled with ultrasound assisted extraction. Biomass and Bioenergy 139, 105616.
[3] Dai, J., Mumper, R. J., 2010. Plant phenolics: extraction, analysis and their antioxidant and anticancer properties. Molecules 15, 7313-7352.
[4] Anastopoulos, I., Karamesouti, M., Mitropoulos, A. C., Kyzas, G. Z., 2017. A review for coffee adsorbents. J Mol Liq. 229, 555-565.
[5] Yamane, K., Kono, M., Fukunaga, T., Iwai, K., Sekine, R., 2014. Field evaluation of coffee grounds application for crop growth enhancement, weed control, and soil improvement. Plant Prod Sci. 17, 93-102.
[6] Cervera-Mata, A., Pastoriza, S., Rufián-Henares, J. A., Párraga, J., Martín-García, J. M., Delgado G. 2017. Impact of spent coffee grounds as organic amendment on soil fertility and lettuce growth in two Mediterranean agricultural soils. Arc. Agron. Soil Sci., 64, 790-804.
[7] Hardgrove, S. J. and Livesley, S. J. 2016. Applying spent coffee grounds directly to urban agriculture soils greatly reduces plant growth. Urban Forestry and Urban Greening http://dx.doi.org/10.1016/j.ufug.2016.02.015

Acknowledgement of the above references herein is not to be inferred as meaning that these are in any way relevant to the patentability of the presently disclosed subject matter.

### BACKGROUND

Spent coffee grounds (SCG), are disposed of in the environment, and thus may be a risk of contamination by high levels of chemical residues such as polyphenols, tannins, and caffeine. On the other hand, if appropriately managed, SCG can be a promising feedstock for conversion into valuable products [1], [2].

Some studies focused on products recovery from SCG, like sugars, flavonoids, antioxidants, and food additives [3], [4]. Only a few studies have focused on the application of SCG as plant growth enhancers, weed control, and soil improvement [5], [6].

A study by Hardgrove and Livesley [7] shows that soil amendment with fresh SCG might produce phytotoxic effect and significantly inhibits plant growth.

### GENERAL DESCRIPTION

The present disclosure is based on the understanding that hydrothermal (HT) treatment can be used for valuable product recovery from SCG.

Specifically, the present disclosure is based on the development of a hydrothermal technology for the extraction of valuable water-soluble compounds from coffee waste.

Thus, in the first aspect of the present disclosure, there is provided a hydrothermal process for the preparation of spent coffee grounds extract (SCG-HT extract). The process comprises:
(i) subjecting an aqueous mixture comprising particulated coffee waste and an aqueous medium to hydrothermal conditions, to obtain a coffee waste slurry including particulates;
(ii) separating at least part of the particulates from said coffee waste slurry, to obtain a coffee waste product;
said hydrothermal conditions comprise a temperature above about 170° C. and a pressure equal or above 1 MPa.

The present disclosure further provides a coffee waste product comprising in an aqueous sample volume of 1 liter any one or combination of the following characteristics:
total antioxidant capacity from about 6000 and about 8000 mg Fe(II) eq.
total phenolic content from about 2000 and about 3000 mg GA eq.
total furfural compounds content from about 1000 ppm and 2000 ppm.

Further, the present disclosure provides methods using the coffee waste product in agriculture. Specifically, there is provided an agricultural method comprising applying to a plant or a plant soil an amount of the coffee waste product disclosed herein, the amount being effective to provide improvement in at least one parameter associated with plant growth, said improvement being in comparison to the same parameter determined in the absence of said coffee waste product application.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a flow chart showing a hydrothermal treatment process of ground coffee waste according to some examples of the present disclosure.

FIG. 2 is a graph showing concentration of furfural 5-hydroxymethyl furfural (HMF) and 5-methyl-furfural in SGT-HT produced at different temperatures (175-275° C.) for 30 min with SLR of 1:5, according to some examples of the present disclosure.

FIGS. 3A-3E are fluorescence excitation-emission matrixes of SGT-HT extracts produced at different temperatures (175-275° C.) according to some examples of the present disclosure and specifically at 175° C. (FIG. 3A), 200° C. (FIG. 3B), 225° C. (FIG. 3C), 250° C. (FIG. 3D) and 275° C. (FIG. 3E).

FIGS. 4A-4B are histograms showing the direct effect of SCG-HT extracts according to some examples disclosed herein, on pathogen growth, and specifically, on growth of Botrytis cinerea (FIG. 4A) and Xantomonas campestris (FIG. 4B).

FIGS. 5A-5C are histograms showing the capacity of SCG-HT extracts at two different dilutions (FIG. 5A and FIG. 5B) to confer resistance against B. cinerea in tomato plants; and an image (FIG. 5C) showing representative infected tomato leaves after treatment with the SCG-HT at the indicated dilutions and obtained at the indicated temperatures.

FIGS. 6A-6D are different histograms showing the capacity of SCG-HT extracts according to some examples to confer resistance in tomato plants, against Xanthomonas campestris pv. Vesicatoria showing number of colony forming units/mg of plant tissue (FIG. 6A) and number of colony forming units normalized to the mean colony forming number in the mock (FIG. 6B); and according to some other examples to confer resistance against Oidium neolycopersici showing the percentage of leaf coverage by a pathogen (FIG. 6C) and number of infected leaves per plant (FIG. 6D).

FIGS. 7A-7F are scatter plots showing the influence of SCG-HT extracts according to some examples cited herein on shoot length (FIG. 7A) and number of leaves (FIG. 7B) measured from 20 to 58 days post seeding; and histograms showing the influence of SCG-HT extracts according to some other examples on leaf complexity (FIG. 7C), number of flowers (FIG. 7D), number of inflorescences (FIG. 7E) and leaf complexity (FIG. 7F).

FIGS. 8A-8D are histograms showing the positive influence of SCG-HT extracts according to some examples cited herein on plant height (FIG. 8A), number of leaflets on 4^{th} youngest leaf (FIG. 8B) number of tiers with set fruit (FIG. 8C), and number of fruits in first tier (FIG. 8D).

FIGS. 9A-9E are box plots showing the positive influence of SCG-HT extracts according to some examples on plant height (FIG. 9A), number of tiers with set fruit (FIG. 9B), number of fruits on first tier (FIG. 9C), number of fruits on second tier (FIG. 9D), and number of leaflets per youngest leaf on fourth tier (FIG. 9E).

FIGS. 10A-10C are bar-dot plots showing the influence of SCG-HT extracts according to some examples of the present disclosure on plant height (FIG. 10A), number tiers with set fruit (FIG. 10B), and number of inflorescences on unset tiers (FIG. 10C).

FIGS. 11A-11C are bar-dot plots showing the influence of SCG-HT extracts according to some examples cited herein on tomato yield (FIG. 11A), average weight per one tomato (FIG. 11B) and an amount of soluble sugars per tomato, expressed as Brix % (FIG. 11C).

FIGS. 12A-12B are scatter plot (FIG. 12A) and a histogram (FIG. 12B) showing the capacity of pretreatment with SCG-HT extracts according to some examples of present disclosure to increase the reactive oxygen species (ROS) production in plant.

FIGS. 13A-13B are histograms showing the capacity of pretreatment with SCG-HT extracts according to some examples cited herein to increase ethylene production in plant measured in wounding-induced model (FIG. 13A) and in elicitor-induced model (FIG. 13B).

### DETAILED DESCRIPTION

The present disclosure is based on the finding that when subjecting spent coffee grounds to a hydrothermal treatment within a hydrolyzer, the resulting coffee waste product (referred to herein by the terms “coffee extract” or “spent coffee ground hydrothermal extract” or by the abbreviation “SCG-HT”) has a dual effect on plant including at least an antimicrobial effect and an improvement in at least one plant parameter.

Thus, in its broadest aspect, the present disclosure provides a process that converts spent coffee waste into coffee waste extracts that have been found to be beneficial, e.g. for various agricultural applications. In some examples, the resulting coffee waste extracts were found to promote plant growth and/or health.

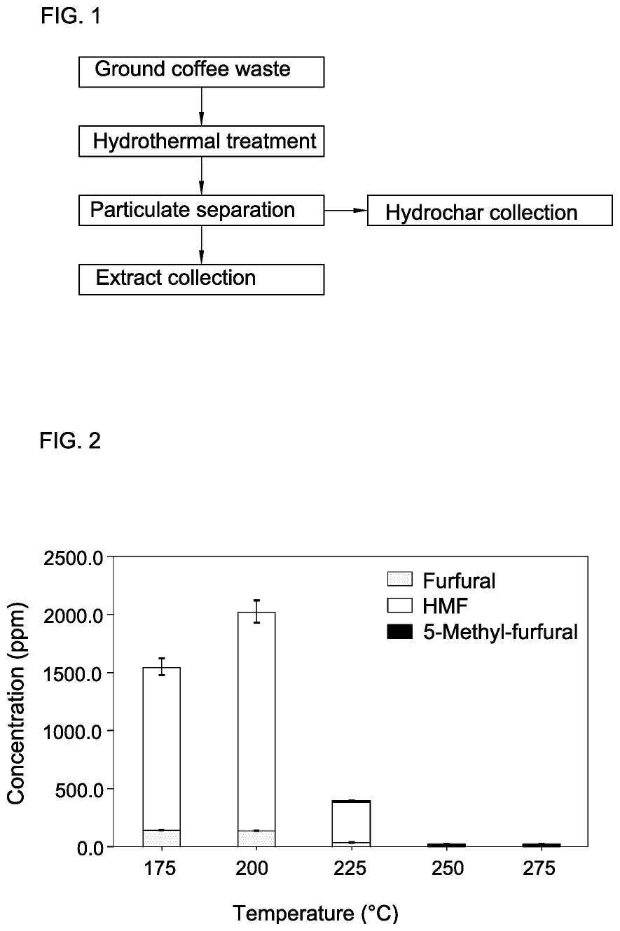

FIG. 1 provides a block diagram of a process according to some examples of the present disclosure, whereby from ground coffee waste, a beneficiary extract is obtained (the coffee waste as further discussed hereinbelow) and a hydrochar that can be utilized in various applications, such as, without being limited thereto, renewable energy applications.

Specifically, the present disclosure provides a hydrothermal process for producing a coffee waste product, the process comprising
(i) subjecting an aqueous mixture comprising particulated coffee waste and an aqueous medium to hydrothermal conditions, to obtain a coffee waste slurry including particulates;
(ii) separating at least part of the particulates from said coffee waste slurry, to obtain a coffee waste product;
said hydrothermal conditions comprise a temperature above about 170° C. and a pressure equal or above 1 MPa.

In the context of the present disclosure the term coffee waste or spent coffee waste is used to encompass at least solid coffee material that has been discarded for any reason acceptable in the art. Discarding can be, for example, after use, due to a defect, spoilage, etc.

The term solid coffee material, as used herein refers to any solid material that is derived or derivable from coffee plant, including, without being limited thereto, coffee beans, coffee pulp, coffee grounds, and any combination of same.

In some examples, the coffee waste is spent coffee, i.e. coffee material that has already been used for the production of a coffee-containing product and the spent solid coffee material is a byproduct/waste therefrom.

In some examples, the coffee waste is spent coffee grounds.

The coffee waste is subjected to a hydrothermal process. To this end, an aqueous mixture comprising the particulated coffee waste (i.e. solid coffee waste) and an aqueous medium is formed. The aqueous medium is water or any water based medium. The water-based medium can comprise additives such as salts, pH adjusting agents, colorants, surface active materials.

In some examples, the aqueous medium is water.

The aqueous mixture can be defined by a solid to liquid ratio (SLR). In some examples, the SLR between the solid coffee waste and aqueous medium is between about 1:20 and about 1:1; at times, between about 1:20 and about 1:2; at times, between about 1:20 and about 1:3; at times, between about 1:20 and about 1:4; at times, between about 1:15 and about 1:4; at times, between about 1:15 and about 1:2; at times, between about 1:10 and about 1:3; at times, between about 1:9 and about 1:3; at times, between about 1:8 and about 1:3; at times, between about 1:7 and about 1:4; at times, between about 1:6 and about 1:3.

In some examples, the SLR is between about 1:6 and about 1:4.

The aqueous mixture is subjected to hydrothermal process under conditions that support/facilitate extraction of the solid coffee waste suspended within the medium.

In the context of the present disclosure, when referring to a hydrothermal process or hydrothermal conditions it is to be understood to involve subjecting the aqueous mixture to at least elevated temperature.

When referring to elevated temperature it is to be understood to encompass any temperature above 100° C. In some examples, the elevated temperature is any temperature above about 170° C.; at times above about 180° C.; at times above about 190° C.; at times above about 200° C.; at times above about 210° C.; at times above about 220° C.; at times above about 230° C.; at times above about 240° C.; at times above about 250° C.; at times above about 260° C.; at times above about 270° C.; at times above about 280° C.; at times above about 290° C.; at times above about 300° C.

When referring to elevated temperature it is to be understood to encompass any temperature below 400° C. In some examples, the elevated temperature is any temperature below about 390° C.; at times, below about 380° C.; at times, below about 370° C.; at times, below about 360° C.; at times, below about 350° C.; at times, below about 340° C.; at times, below about 330° C.; at times, below about 320° C.; at times, below about 310° C.; at times, below about 300° C.; at times, below about 290° C.; at times, below about 280° C.; at times, below about 270° C.; at times, below about 260° C.; at times, below about 250° C.; at times, below about 240° C.; at times, below about 230° C.; at times, below about 220° C.; at times, below about 210° C.; at times, below about 200° C.; at times, below about 190° C.; at times, below about 180° C.

In some examples, the elevated temperature comprises a temperature between about 170° C. and about 400° C.; at times, between about 170° C. and about 350° C.; at times, between about 170° C. and about 300° C.; at times, between about 170° C. and about 320° C.; at times, between about 170° C. and about 330° C.; at times, between about 170° C. and about 280° C.; at times, between about 170° C. and about 260° C.; at times, between about 170° C. and about 250° C.

In some examples, the elevated temperature is about 175° C.=10° C.

In the context of the present disclosure, when referring to a hydrothermal process or hydrothermal conditions it is to be understood to involve subjecting the aqueous mixture to at least elevated pressure. In the context of the present disclosure, when referring to elevated pressure it is to be understood to encompass a pressure above atmospheric pressure. Pressure drop will be used a control parameter (alarming that the system is leaking).

In some examples, the elevated pressure is any pressure equal or above 1 MPa; at times, above 2 MPa; at times, above 3 MPa; at times, above 4 MPa; at times, above 5 MPa; at times, above 6 MPa; at times, above 7 MPa; at times, above 8 MPa; at times, above 9 MPa; at times, above 10 MPa; at times, above 11 MPa; at times, above 12 MPa; at times, above 13 MPa; at times, above 14 MPa; at times, above 15 MPa; at times, above 16 MPa; at times, above 17 MPa; at times, above 18 MPa; at times, above 19 MPa; at times, above 20 MPa; at times, above 21 MPa; at times, above 22 MPa; at times, above 23 MPa; at times, above 24 MPa; at times, above 25 MPa; at times, above 26 MPa; at times, above 27 MPa; at times, above 28 MPa.

In some examples, the elevated pressure is any pressure below about 30 MPa; at times, below about 29 MPa; at times, below about 28 MPa; at times, below about 27 MPa; at times, below about 26 MPa; at times, below about 25 MPa; at times, below about 24 MPa; at times, below about 23 MPa; at times, below about 22 MPa; at times, below about 21 MPa; at times, below about 20 MPa; at times, below about 19 MPa; at times, below about 18 MPa; at times, below about 17 MPa; at times, below about 16 MPa; at times, below about 15 MPa; at times, below about 14 MPa; at times, below about 13 MPa; at times, below about 12 MPa; at times, below about 11 MPa; at times, below about 10 MPa; at times, below about 9 MPa; at times, below about 8 MPa; at times, below about 7 MPa; at times, below about 6 MPa; at times, below about 5 MPa; at times, below about 4 MPa; at times, below about 3 MPa; at times, below about 2 MPa.

In some examples, the elevated pressure is any pressure between 1 MPa and 30 MPa; at times, between 1 MPa and 20 MPa; at times, between 1 MPa and 10 MPa.

The pressure will, at times, depend on the selected temperature and Table 1 provides possible relations between selected temperature and minimal pressure required within the hydrolyzer.

TABLE 1
Temperature-Pressure relationship

| | Water saturation | Minimum pressure |
|---|---|---|
| Temperature (° C.) | pressure (MPa) | required (MPa) |
| 150 | 0.478 | 0.5 |
| 175 | 0.894 | 1.0 |
| 200 | 1.553 | 1.6 |
| 225 | 2.548 | 2.6 |
| 250 | 3.977 | 4.0 |
| 275 | 5.949 | 6.0 |
| 300 | 8.588 | 9.0 |

In some examples, the hydrothermal process can also be characterized by residence time of the aqueous mixture under the hydrothermal conditions. The residence time would typically be associated with the elevated temperatures employed under the hydrothermal conditions. In some examples, a residence time suitable for processing coffee waste into the coffee waste extract of the present disclosure is between several minutes and several hours; at times, for at least 5 min; at times, at least 10 min; at times, at least 15 min; at times, at least 20 min; at times, at least 25 min; at times, at least 30 min; at times, at least 35 min; at times, at least 40 min; at times, at least 45 min; at times, at least 50 min; at times, at least 55 min; at times, at least 60 min.

In some examples, the residence time is for not more than 3 hours, at times, not more than 2 hours, at times, not more than 1 hour.

In some examples, the residence time is between 20 min and 60 min.

In some examples the hydrothermal conditions comprise a temperature of between about 170° C. and 210° C. and residence time of about 30 min±10 min.

In some examples, the process comprises a SLR of about 1:5, and hydrothermal conditions that comprise at least a temperature of between about 170° C. and 210° C. and residence time of about 30 min±10 min.

The hydrothermal conditions can be applied in any device configured for subjecting the aqueous mixture to elevated temperatures and for withstanding elevated pressure therewithin.

In some examples, the method is performed within a pressurized reaction vessel.

In some examples, the method is performed within a hydrothermal tank.

In some examples, the method is performed within hydrolyzer.

The hydrothermal conditions result in the formation of a coffee waste slurry. The coffee waste slurry comprises solids suspended in the aqueous medium, from which the particulate matter (solid coffee waste) needs to be separated in order to obtain the desired coffee waste extract. Thus, the disclosed process also comprises separating the particulates from the coffee waste slurry, to obtain thereby the coffee waste extract.

In the context of the present disclosure, the term particulates is to be understood to refer to any solid matter in the slurry that is above 20 micron, at times, above 15 micron, at times, above 13 micron or above 11 micron. The size of the particulates can be determined by any technique known in the art.

Further, in the context of the present disclosure, the separation between the particulates from the coffee waste slurry can include any one or combinations of filtration, sedimentation, ultracentrifugation, or any combination thereof.

In some examples, particulates are being separated from the coffee waste slurry by filtration.

In some examples, particulates are being separated from the coffee waste slurry by sedimentation.

In some examples, particulates are being separated from the coffee waste slurry by ultracentrifugation.

The separation of the particulates from the slurry result in the obtaining of a coffee waste extract. In some cases, the coffee extract comprises particles having a size of less than 15 micron, at times, less than 13 micron, or even less than 11 micron.

The coffee waste product can be used as is for various applications. Yet, in some examples, the coffee waste product can be subjected to further processing steps, before use thereof, e.g. in agriculture.

In the context of the present disclosure, the term coffee waste product is to be understood to refer to the direct product after hydrothermal treatment and particulates removal from the resulting slurry as well as any product resulting from one or more further processing of the extract, as described below.

In some examples, the coffee waste product is subjected to a demulsification step. The demulsification step can result in a de-fatted water coffee. As may appreciated by those versed in the agricultural industry, the de-fatting may be beneficial to avoid contamination of soil with waste-derived fatty acids and oils.

In some examples, demulsification can comprise any one or combination of chemical demulsification, ultrasonic demulsification; centrifugal demulsification; thermal demulsification; electrical demulsification and mechanical demulsification. Such demulsification processes are known in the art.

In some examples, the method disclosed herein comprises drying the coffee waste product. In the context of the present disclosure, drying can be performed on the extract as obtained after solid removal, yet, also on the product after being subjected to one or more additional processing steps. Drying can be by any means known in the art. Without being limited thereto, drying is by any one or combination of freeze drying, spray drying, air drying, heat drying etc.

In some examples, drying comprises at least freeze drying.

In some examples, drying comprises at least spray drying.

In some examples, drying comprises at least air drying.

In some examples, drying comprises at least heat drying.

The method disclosed herein provides a coffee waste product.

In the context of the present disclosure it is to be understood that the coffee waste product is not fresh coffee products or freeze-dried coffee products, such as coffee drinks, coffee bars, etc, suitable for human consumption.

In some examples, the coffee waste product can be characterized by any one or combination of: total reducing capacity expressed by amount of Fe(II) equivalents; total phenolic content expressed by amount of gallic acid (GA) equivalents, total furfural compounds content.

In some examples, the coffee waste product is characterized based on a 1 liter aqueous sample thereof.

In some examples, in a 1 liter aqueous sample of the coffee waste product, the coffee waste product is characterized by an amount of Fe(II) eq. of between about 6,000 and 8,000 mg, as determined by Ferric Reducing Antioxidant Power (FRAP) assay, as known in the art.

In some examples, in a 1 liter aqueous sample of the coffee waste product, the coffee waste product is characterized by total phenolic content from about 2,000 mg GA equivalent and about 3,000 mg GA equivalent as determined by Folin method, as known in the art.

In some examples, in a 1 liter aqueous sample of the coffee waste product, the coffee waste product is characterized by total furfural compounds content from about 1,000 ppm and about 2,000 ppm as determined by gas chromatography.

In the context of the present disclosure, when referring to furfural compounds it is to be understood to encompass furfural per se having the chemical formula

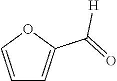

as well as any derivative thereof.

In some examples, the furfural compound comprises at least furfural.

In some examples, the furfural compound comprises at least hydroxymethylfurfural (HMF).

In some examples, the furfural compound comprises at least 5-methylfurfural.

In some examples, the coffee waste extract comprises a combination of at least two of furfural, hydroxymethylfurfural (HMF) and 5-methylfurfural.

In some examples, the coffee waste product comprises furfural and HMF.

In some examples, the furfural compounds comprise predominantly HMF, e.g., at least twice more than any other furfural compound within the coffee waste product.

The coffee waste product can also be characterized by its total dissolved solids (TDS) as determined by filtration of the raw extract followed by drying the filtrate in 105° C. overnight. By combusting the dried solids (both organic and inorganic) at 550° C. for 4 h, both organic and inorganic substances can be determined as dissolved organic substances (DOS) and dissolved inorganic substances (DIS).

In some examples, the coffee waste product is characterized by DOS of between about 15 g/liter and about 70 g/liter.

In some further examples, the coffee waste product is characterized by DIS of between about 3 g/liter and about 7 g/liter.

In yet some further examples, the coffee waste product is characterized by the DOS:DIS ratio being between about 3 and about 20.

The coffee waste product can also be characterized by its potassium content, which can be determined by any method known in the art.

In some examples, the coffee waste product is characterized by potassium content of between about 100 mg/liter and about 500 mg/liter.

As noted above, the coffee waste product obtained or obtainable by the method disclosed herein exhibits unique beneficial properties in agriculture.

In some examples of the presently disclosed subject matter, the coffee waste product unexpectedly exhibited anti-microbial properties.

In some examples of the presently disclosed subject matter, the coffee waste product unexpectedly exhibited plant stimulating properties.

In some examples of the presently disclosed subject matter, the coffee waste product unexpectedly exhibited anti-microbial properties concomitant with beneficial plant stimulating properties. In other words, it was unexpected found that the coffee waste product has a dual beneficial effect.

In the context of the present disclosure, when referring to anti-microbial properties it is to be understood to refer to preventative treatment as well as post-infection treatment. The treatment can be any one of fungicidal, bactericidal, anti-viral, pesticidal effect etc.

In the above context, the term treat, treating, treatment is to be understood to encompass any one of inhibiting, slowing, or reversing the progression of a condition brought about in plants by plant pathogens, including bacterial, fungal, viral, insect or other plant pests, spores or hyphae; ameliorating symptoms of such condition or preventing the appearance of symptoms of the condition.

Further, in the above context, the term prevention, preventing and prevent is to be understood to encompass any action resulting in a reduction or elimination in the chances of developing a certain condition brought about in plants by plant pathogens, including bacterial, fungal, viral, insect or other plant pests, spores or hyphae. Thus, the term prevent refers to prophylactic regime.

In some examples, the coffee waste product can be used as a fungicide.

In some examples, the coffee waste product can be useful against fungi belonging to the following genera: Botrytis Sclerotinia, Alternaria, Pythium, Phytopthora, Fusarium, Oidium, Lasodiplodia, Penicillium, Aspergillus, Talaromyces, Macrophomina, Verticillium and Cladosporium. In some examples, the coffee waste product is useful against Botrytis cinerea.

In some examples, the coffee waste product can be useful as a bactericide.

In some examples, the coffee waste product can be useful against a bacterium belonging to the following genera: Xanthomonas Clavibacter, Pseudomonas, Xyllela, and Erwinia, In some examples, the coffee waste product is useful against Xanthomonas campestris.

In the context of the present disclosure, when referring to plant stimulating properties it is to be understood to encompass any effect exhibited by an improvement in at least one parameter associated with plant growth or plant health.

In the context of the present disclosure, the term parameter associated with plant growth or health is to be understood to refer to microbial load, pest infestation level, plant yield, plant biomass, plant height, plant part complexity, plant part dimensions, number of plant parts, number of tiers with set fruit, number of fruits in a specific tier, number of leaflets on a set youngest leaf, number of inflorescences on unset tiers, amount of soluble sugars per plant (expressed as Brix %) and any combination of same.

In the context of the present disclosure, when referring to microbial load it is to be understood to refer to the number and type of microorganisms contaminating the plant or plant part (e.g. infected area).

In the context of the present disclosure, when referring to pest infestation level it is to be understood to refer to the level of infestation (occurrence) by one or more pest species in an area or location on the plant or plant part, such occurrence being at or being potentially at an intolerable level to the plant's health and/or growth.

In the context of the present disclosure, when referring to plant part it is to be understood to encompass the plant as a whole as well as any part thereof, such as the roots, stems, leaves, flowers, inflorescences, fruits.

In the context of the present disclosure the term plant yield has the meaning as known in the art and may be exhibited by increase in harvested plant material or number of plants per growing area.

In the context of the present disclosure the term plant biomass is to be understood to refer to weight of plant material obtained from any part of the plant, being taken from above and below ground surface.

In the context of the present disclosure the term plant height is to be understood to refer to height of plant material as measured from the growing media surface, e.g. taken from above ground surface to the top, most highest part of the plant.

In the context of the present disclosure the term plant part complexity is to be understood to refer to number of branching points in aerial or underground parts of the plant.

In the context of present disclosure, the term plant part dimension, is to be understood to refer to at least one dimension of the plant part, e.g. length, width, diameter, surface area, volume or any combination thereof.

In the context of present disclosure, the term number of plant parts, is to be understood to refer to number of roots, stems, leaves, flowers, inflorescences, and/or fruits.

As used herein, the term tier is intended to mean a group of flowers or fruits that emerge from the same point or level along the stem of a tomato plant. Each tier typically produces several fruits, and tomato plants can have multiple tiers or clusters of fruit at different heights along the stem.

In the context of the present disclosure the term number of tiers with set fruit is to be understood to refer to the number of groups of set fruits.

In the context of the present disclosure the term number of fruits in a specific tier is to be understood to refer to the number of fruits on a selected tier, e.g. first tier, fourth tier.

In the context of the present disclosure the term number of leaflets on a set youngest leaf is to be understood to refer to the number of leaflets on a selected youngest leaf, e.g. on the 4^{th} youngest leaf.

In the context of the present disclosure the term number of inflorescences on unset tiers is to be understood to refer to the number of inflorescences on tiers where there are no set fruit.

In the context of the present disclosure the term amount of soluble sugars per plant (expressed as Brix %) is to be understood to have the meaning as known in the art, e.g. by dividing dissolved solids by the sum of the dissolved solids plus the water, all multiplied by 100.

In view of the herein disclosed findings, the coffee waste product can be used in agriculture, i.e., as an agricultural coffee waste product.

In some examples, the coffee waste product comprises the coffee waste product per se; yet in some other examples, the coffee waste product can be combined with an agriculturally acceptable carrier.

In some examples, the treatment of plant with the presently disclosed coffee waste product can be in combination with other one or more agriculturally active compounds.

In some examples, the coffee waste product is provided to the plant in combination with an agriculturally acceptable elicitor. By the term “agriculturally acceptable elicitor” it is to be understood to encompass any one or combination of compound, microorganism, macromolecule as well as a physical effect on the plant (e.g. wounding of the plant) that is found or known to induce an innate immune response in the plant.

The combined administration, in the context of the presently disclosed subject matter can include concomitant administration (e.g. in the same formulation or in separate formulations administered simultaneously).

The combined administration, in the context of the presently disclosed subject matter can also include separate administration, e.g. in sequence, according to different treatment schedules within a treatment period etc.

In some examples of the presently disclosed subject matter, the combined treatment of the plant with the coffee waste product and the elicitor provides an effect that is greater than the effect of each treatment when applied alone (i.e. the coffee waste product treatment alone, or the elicitor treatment alone).

The coffee waste product according to the preset disclosure is thus for use in an agricultural method. In accordance with the present disclosure, there is also provided an agricultural method, the method comprises applying to a plant or a plant soil an amount of a coffee waste product a disclosed herein, the amount being effective to provide improvement in at least one parameter associated with plant growth or health, as defined hereinabove, the improvement being in comparison to the same parameter determined in the absence of the coffee waste product application.

In the context of the presently disclosed subject matter, and for sake of sufficiency of the present disclosure it is to be understood that all terms and definitions provided hereinabove with literal reference to any one of the presently disclosed aspects, e.g. method of producing the coffee waste product, the coffee waste product or the method of using the coffee waste product should be used independently for interpreting other aspects, even if not explicitly and/or literally defined with respect to the said other aspect.

Thus, all aspects and non limiting examples of the presently disclosed subject matter should be interpreted by the definitions provided herein without being limited to the particular aspect with which they are literally provided.

In some examples, the coffee waste product is applied onto the soil and/or onto the plant in liquid form.

In some examples, the coffee waste product is applied by irrigation, this includes, without being limited thereto, drip irrigation, spray irrigation, manual irrigation.

In some examples, the coffee waste product is applied onto the soil and/or onto the plant in solid/particulate form. The solid/particulate product can be spread onto or in the vicinity of the plant.

In some examples, the disclosed method comprises treatment of the plant with the coffee waste product and at least one additional agricultural treatment. The at least one additional agricultural treatment can be any one from which the plant will benefit in terms of any one of the above listed parameters associated with the plant growth and/or health.

In some examples, the method comprises separate or simultaneous treatment of the plant (as defined above) with the presently disclosed coffee waste product and at least one agriculturally acceptable elicitor.

As used in this specification and the appended claims, the term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range.

As used in this specification and the appended claims, the singular forms “a”, “an” and “the” include plural referents unless the context clearly dictates otherwise.

Further, throughout this specification and the Examples and claims which follow, unless the context requires otherwise, the word “comprise”, and variations such as “comprises” and “comprising”, will be understood to imply the inclusion of a stated component, integer or step or group of components, integers or steps but not the exclusion of any other component, integer or step or group of components, integers or steps.

The following Examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### DESCRIPTION OF SOME NON-LIMITING EXAMPLES

### Example 1: Hydrothermal Extraction Process

Hydrothermal treatment (HT) of spent coffee grains (SCG) provided a coffee waste product referred to in the non-limiting examples by the term “SCG-HT extract”. The treatment was performed at different temperatures (175, 200, 225, 250, 275, 300 and 325° C.) and different solid to liquid ratio (SLR) (1:3, 1:4, 1:5, 1:10 and 1:20). Solid and liquid phases were separated by vacuum filtration with Whatman No. I filter. Then, it was treated with ice ultrasonication for 45 min and ultracentrifuged at 10,000 rpm for 20 min to de-emulsify the product. Then, the physicochemical properties of the aqueous phase were characterized and transformed for bioassays.

At higher temperatures such as 300° C. and 325° C., compounds in the SCG-HT extract are converted into bio-oil or other toxic compounds. At higher SLR of 1:10 and 1:20, there are fewer compounds available for extraction, so the process's efficacy was found to be lower. The lower temperature process and lesser SLRs have produced more valuable compounds for agricultural applications, as determined experimentally. The particular process improvement was achieved at the SLR of 1:5.

Physiochemical analysis of SCG-HT extracts at different temperatures (175-275° C.) is summarized in Table 2. The pH of the SCG-HT extracts at SLR of 1:5 ranges from 3.5 to 4.5; The pH slightly increases with an increase in HT temperature due to the conversion of acids to alcoholic or phenolic groups. The antioxidant capacity of the extracts was analyzed using the FRAP method according to Benzie and Strain, (Analytical Biochemistry 239, 70-76, (1996)) incorporated herein by reference, which shows that the antioxidant capacity is declining with an increase of treatment temperature from 139 to 89 mg Fe(II) Eq./L. Total phenol content analyzed using the Folin method according to Ainsworth and Gillespie (Nature Protocols 2(4), 875-877, (2007)), incorporated herein by reference, shows that the phenol content decreased with increased temperature in agreement with the FRAP test. The highest phenol content (144.2±2.1 mg GAE/L) was observed in SCG-HT extracts of 200° C. Phenolic compounds are known to enhance the antioxidant properties of the plants, reduce plant stress and help in plant growth and development. SCG-HT extracts also contain necessary nutrients such as potassium (K), enhancing the plant root and shoot elongation. Total dissolved solids (TDS) analysis delivers the same trend of results, i.e., the decrease of TDS (52.9 to 22.1 mg/L) as processing temperature increases.

The SCG-HT extracts were further characterized by the Gas Chromatography (GC). Gas chromatography was performed under the following conditions: Injection volume 1 μl. Injector temperature 250° C. Column flow (at 275° C.) 50 ml/min Helium. GC column: Restek Rxi-5 ms, 30 m×0.25 mm×0.25 μm. GC program: Hold 1 min at 50° C., ramp 5° C./min, final temperature 300° C., hold 5 min. Total run time 56 min. Detector; FID at 300° C. GC analysis revealed furfural compounds, the dehydration products of sugars, which may contribute to the antioxidant capacity of the extracts. In agreement with the other tests, total furfural compounds decreased with increased temperature (Table 2).

TABLE 2
Physiochemical analysis of spent coffee grounds hydrothermal extracts

| Physiochemical | Hydrothermal temperature | | | | |
|---|---|---|---|---|---|
| parameters | 175° C. | 200° C. | 225° C. | 250° C. | 275° C. |
| pH | 3.9 ± 0.1 | 3.5 ± 0.1 | 3.8 ± 0.1 | 4.1 ± 0.0 | 4.2 ± 0.2 |
| Total dissolved | 69.5 ± 0.2 | 45.8 ± 05 | 30.8 ± 0.7 | 20.6 ± 0.2 | 26.9 ± 0.2 |
| solids (g/L) | | | | | |
| Dissolved organic | 65.9 ± 0.1 | 42.4 ± 0.5 | 27.7 ± 0.8 | 17.0 ± 0.5 | 20.2 ± 1.0 |
| substances (g/L) | | | | | |
| Dissolved inorganic | 3.6 ± 0.0 | 3.4 ± 0.0 | 3.1 ± 0.0 | 3.6 ± 0.3 | 6.7 ± 0.8 |
| substances (g/L) | | | | | |
| Total antioxidant | 7,117.3 ± 68.4 | 6,859.5 ± 28.1 | 7,039.3 ± 276.3 | 7,135.3 ± 193.8 | 6,726.1 ± 91.2 |
| capacity | | | | | |
| (mg Fe (II) Eq./L) | | | | | |
| Total phenol | 2,668.6 ± 48 | 2,869.8 ± 82 | 2,420.4 ± 48 | 2,466.5 ± 76 | 2,775.0 ± 104 |
| content | | | | | |
| (mg GAE/L) | | | | | |
| Total furfural | 1,545.5 ± 27.3 | 1,949.4 ± 161.3 | 398.2 ± 27.6 | 25.7 ± 1.9 | 25.9 ± 0.6 |
| compounds | | | | | |
| (mg/L) | | | | | |
| 2-furan- | 151.9 ± 3.3 | 141.4 ± 11.3 | 34.8 ± 4.0 | ND | ND |
| carboxaldehyde | | | | | |
| (furfural) (mg/L) | | | | | |
| 5-Hydroxymethyl- | 1393.5 ± 24.1 | 1807.9 ± 156.9 | 337.9 ± 23.6 | ND | ND |
| furfural (HMF) | | | | | |
| (mg/L) | | | | | |
| 5-Methyl-furfural | ND | ND | 25.5 ± 0.7 | 25.7 ± 1.9 | 25.9 ± 0.6 |
| (mg/L) | | | | | |
| Potassium (mg/L) | 265.3 ± 3.8 | 245.1 ± 6.0 | 204.8 ± 4.6 | 325.7 ± 8.2 | 322.6 ± 4.8 |
| Electrical | 3.7 ± 0.1 | 3.9 ± 0.1 | 3.9 ± 0.1 | 4.0 ± 0.2 | 4.1 ± 0.1 |
| conductivity | | | | | |
| (mS/cm) | | | | | |

GC-MS analyses provided in FIG. 2 identified two key compounds: the aldehyde furfural and 5-hydroxymethyl furfural (HMF). High concentrations of those two compounds were detected at the extracts from the low temperature process (175-200° C.), while negligible concentration at the extracts from high temperature process (225-275° C.) (FIG. 2). Both furfural and HMF are degradation products from 5-carbon sugars that occurs under mild hydrothermal treatment. Furthermore, at the extracts resulting from high temperature process we identified the compound 5-methylfurfural, probably a degradation product of HMF. Both furfural and HMF were reported in the past to affect biological processes; therefore, we suspect that their presence at the low-temperature extracts is a key that can be useful for plant growth enhancement. To summarize, the physiochemical analysis teaches that higher process temperatures reduce the recovery of valuable compounds beneficial for plant growth enhancement.

The extracts were further characterized by excitation-emission matrices (EEMs) of fluorescence. All extracts had been diluted to obtain solutions with absorbance lower than 0.05 at 250 nm. Fluorescence of each SCG-extracts was measured in a 1 cm fluorescence-free quartz cuvette using spectrofluorometer (Shimadzu RF-5301PC), equipped with 150-W Xenon lamp (Ushio Inc., Japan). The procedure used for obtaining the EEMs was similar to that described by Borisover et al. (Water Research, 43(12), 3104-3116 (2009)) incorporated herein by reference. Briefly, EEMs were obtained at room temperature, with the excitation and emission band-pass slit widths of 5.0 nm. Fluorescence emission spectra between 220 and 600 nm were collected at 2-nm increments, with excitation wavelengths ranging from 220 to 590 nm at 5-nm increments.

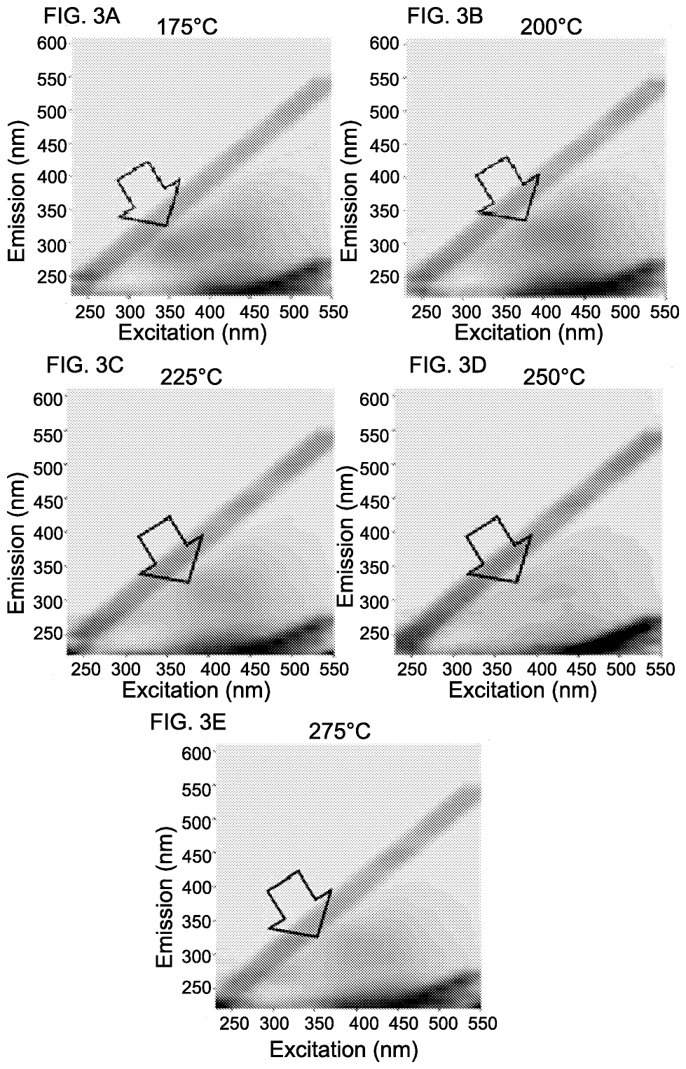

The results of EEM analysis are shown on FIG. 3. While strong signals were observed in in the extracts from low temperature process (175-200° C.) (FIG. 3A-FIG. 3B) the signal faded in extracts from high temperature process (225-275° C.) (FIG. 3C-FIG. 3E). Without being limited thereto, it is presently understood that EEM reflect the presence or absence of soluble organic carbon that may be related to the agricultural activity of the SCG extracts, with the signal fading indicating the lower level/absence of the relevant compounds.

### Example 2: Direct Antimicrobial Effect of SCG-HT Extracts

Direct antimicrobial effect of the SCG-HT extract was measured using two prominent plant pathogens: the fungus Botrytis cinerea (Bc) and the bacterium Xanthomonas campestris pv. Vesicatoria (Xcv). Bc is a fungus with a necrotrophic lifestyle and an extensive range of hosts. Bc causes gray mould disease in more than 200 dicotyledonous and a few monocotyledonous plant species. Xcv causes bacterial leaf spot (BLS) on peppers and tomatoes. It causes symptoms throughout the above-ground parts of the plant including leaf spots, fruit spots and stem cankers.

For the evaluation of direct antimicrobial effect, both pathogens were cultured on appropriate media (i.e., potato dextrose agar for Bc and Luria Bertani broth for Xcv) in the presence of 10⁻¹, 10⁻², and 10⁻³ serial dilutions of relevant SCG-HT extracts (175° C., 200° C., 275° C.) or LB broth (mock)) and the pathogen growth was monitored. The growth of Bc was evaluated by measuring the area of the colonies at 48 h post-inoculation, and the growth of Xcv was evaluated by measuring optical density at 600 nm (OD600) after 18 hours of incubation.

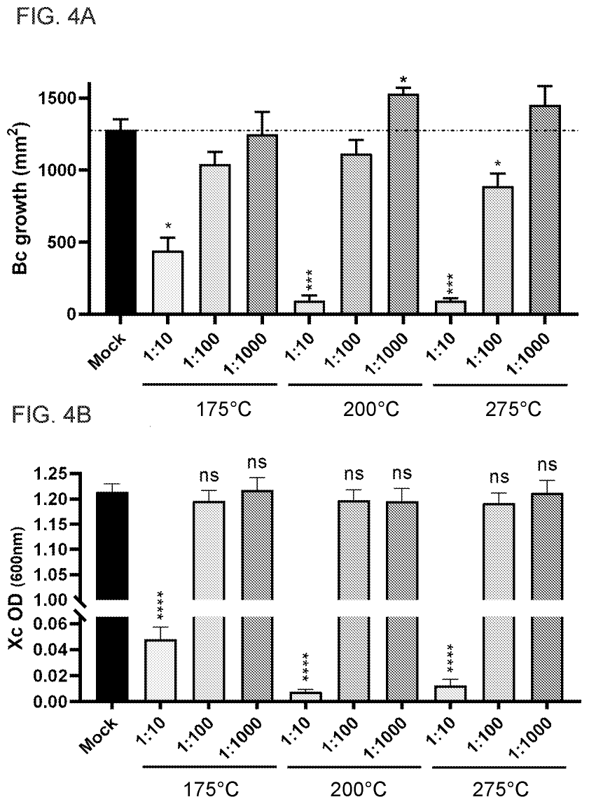

FIG. 4A-FIG. 4B present the antimicrobial test results: FIG. 4A—antifungal activity against Bc. Quantification of results from three biological repeats±SE, N≥3. Asterisks (differences between Mock and treatment) significance in one-way ANOVA with a Bonferroni post hoc test, *p<0.05, ***p<0.001. and FIG. 4B—antimicrobial activity against Xcv. Quantification of results from six biological repeats ±SE, N≥6. Asterisks (differences between Mock and treatment) significance in one-way ANOVA with a Bonferroni post hoc test, ****p<0.001, ns=non-significant.

In the highest concentration tested (dilution factor 10⁻¹), all different extracts (175° C., 200° C., and 275° C.) had a toxic effect, leading to severe retardation in pathogen growth compared to mock, with the 175° C. extracts having the mildest toxic effect (FIG. 4A-FIG. 4B). Dilutions of 10⁻² of the different extracts had some toxic effect on the growth of Bc (FIG. 4A) but no impact on the growth of Xcv (FIG. 4B). When testing the impact of 10⁻³ dilutions, we observed a mild positive effect on the Bc growth rate (FIG. 4A) and no impact on Xcv growth (FIG. 4B).

### Example 3: SCG-HT Extract Priming for Plant Increased Resistance

Biostimulant activity of the coffee extracts and the capacity of the SCG-HT extracts to induce increased plant resistance to pathogens were examined. The experiments were conducted using three pathosystems: tomato-Botrytis cinerea (Bc), tomato-Xanthomonas campestris (Xcv), and tomato-Oidium neolycopersici (On). The system was first calibrated with various extracts using B. cinerea, with the additional pathogens being subsequently tested on the selected extracts. Tomato seedlings were grown with an optimal fertilization and irrigation interface in a temperature-controlled greenhouse (20-30° C.) clean from pests and diseases for approximately 40 days. Three days and one hour before inoculation, the plants were treated with different concentrations of relevant coffee extracts by root-zone irrigation. After infection with pathogens, plants (or infected tissue) were transferred to a high humidity box for 24 h-76 h to allow optimal development of the disease, and disease development was monitored by quantifying the lesion area.

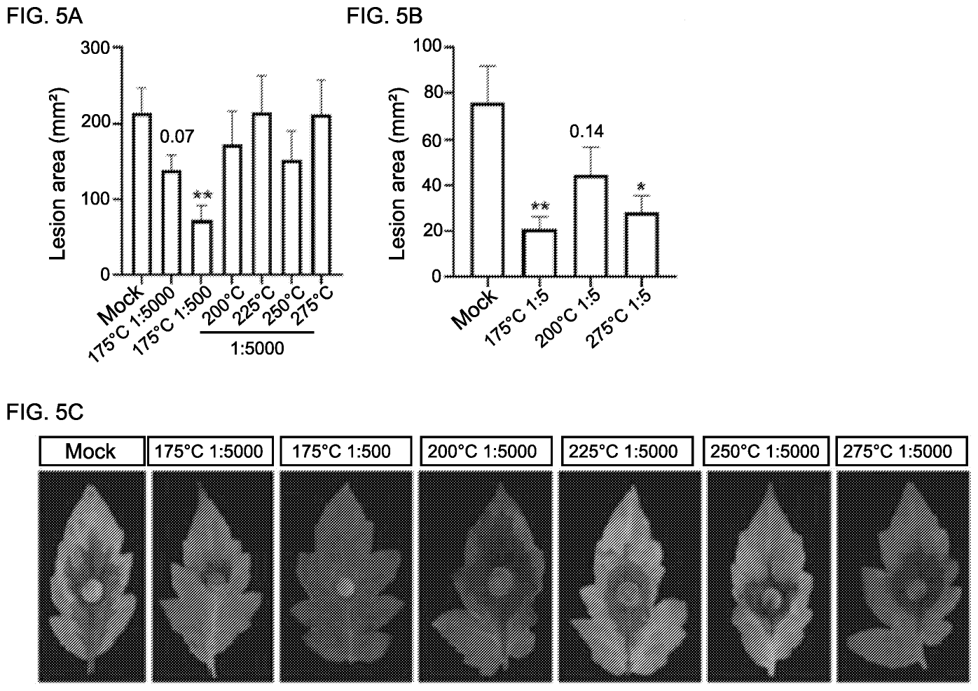

As evident from FIG. 5A-FIG. 5C, pre-treatment with the SCG-HT extracts confered significant resistance to tomato plants against Botrytis cinerea: bars (FIG. 5A-FIG. 5B) represent the mean values of the lesion area, and the error bars represent the standard error of the mean (n=7 biological repeats). Asterisks indicate significant differences between mock and each treatment in an unpaired two-tailed t-test with Welch's correction. (FIG. 5C) shows representative images of Bc infected leaves.

A similar resistance-eliciting effect has been obtained in tomato against Xanthomonas campestris (Xcv) Oidium neolycopersici (On).

Tomato plants were inoculated with 10⁵ CFU/mL of Xcv and 10⁴ conidia/mL of On, and disease levels were evaluated three days and 10 days after the inoculation, respectively. The infection was evaluated by pathogen titer (number of CFU per mg of tissue) for Xcv, and by assessing the percentage of infected leaf tissue out of the total leaf area, and by the number of infected leaves per plant for On.

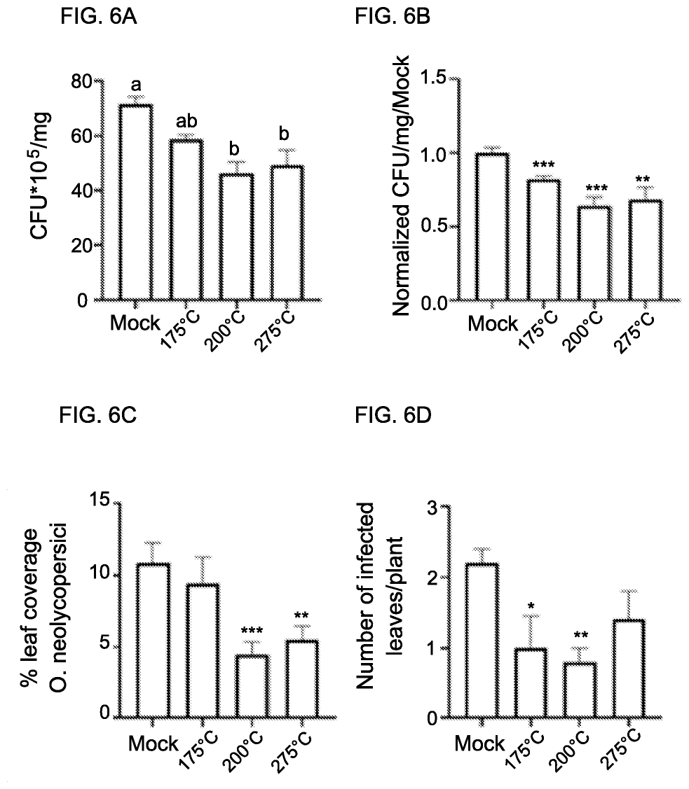

FIG. 6A-FIG. 6D summarize the results of these experiments:

Xcv infection: FIG. 6A shows number of colony-forming units*10⁵/mg tissue. FIG. 6B shows the number of colony-forming units normalized to the mean number of colony-forming units in the mock. Quantification of results from eight biological repeats ±SE. Asterisks and letters represent significance in one-way ANOVA with a Tukey (a) or Bonferroni (b) post hoc test, *p<0.05, **p<0.01, ***p<0.001;

On infection: FIG. 6C shows infected leaf out of total leaf area; FIG. 6D shows the number of infected leaves per plant. The average ±SEM of 5 independent replicates is shown N>20. Asterisks represent statistical significance in an unpaired two-tailed t-test with Welch's correction (*p-value<0.05; **p-value<0.01; ***p-value<0.001).

### Example 4: Bio-Stimulation of Plant Growth by SCG-HT Extract

The effect of the SCG-HT extracts on parameters of plant growth and development was evaluated. The assessment of plant growth following the various treatments examined whether there is a yield cost due to activation of plant resistance/defense mechanisms or whether there are phytotoxic effects of the different SCG-HT extracts, important parameters from an agricultural point of view. The shoot length, number of leaves per plant (both measured 20-58 days post-seeding), and plant height (measured three weeks after the second treatment) were evaluated as the markers of phytotoxic effect.

Furthermore, the direct biostimulatory effect of SCG-HT extracts on plant growth was also examined by these experiments. Plants were irrigated with 5 mL of 10⁻² SCG-HT (175° C., 200° C., and 275° C.) or water (as a mock), three times: 14 days after seeding, 10 days after the first treatment, and again 10 d after the second treatment. The number of flowers and inflorescences per plant and leaf complexity (all measured 58 days after seeding) were considered the biostimulatory activity markers.

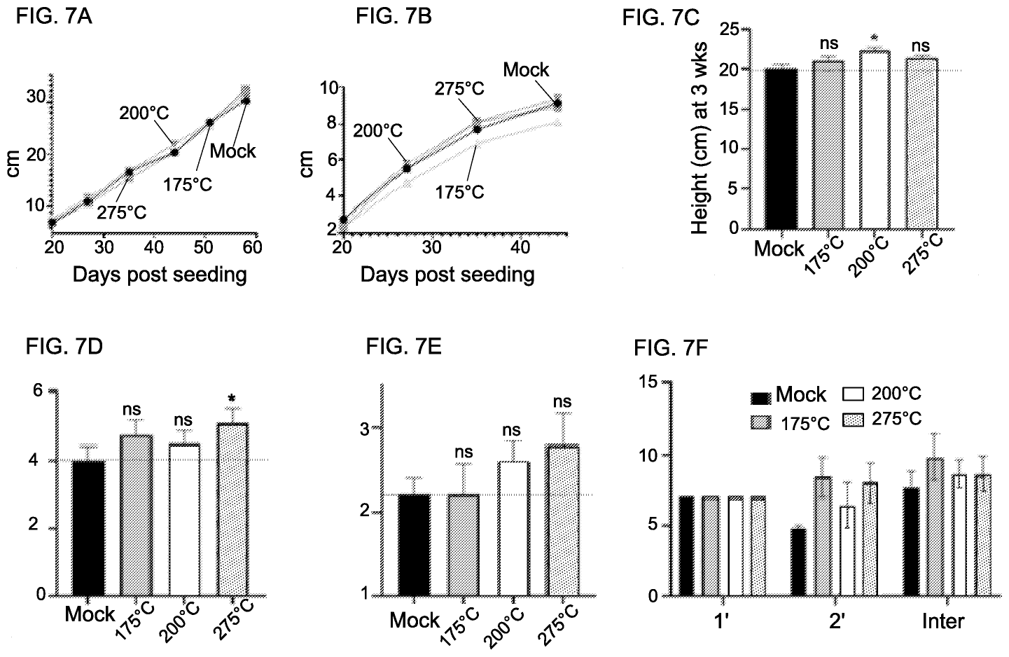

As shown in FIG. 7A-FIG. 7F, no toxic effect of SCG-HT extracts administered to plant was observed (FIG. 7A-FIG. 7F). Furthermore, a positive impact on growth and potential yield (expressed as the No. of flowers and inflorescences) was observed (FIG. 7D-FIG. 7E). Asterisks represent statistical significance in an unpaired two-tailed t-test with Welch's correction (*p-value<0.05).

### Example 5: Field Test

The effect of the SCG-HT extracts on parameters of tomato plant growth and development was further evaluated in a large scale field experiment. The assessment of plant growth following two treatment protocols (designated hereinbelow P1 and P2) examined whether there is a yield cost due to activation of plant resistance/defense mechanisms or whether there are phytotoxic effects of the different SCG-HT extracts.

Three different dilutions of the SCG-HT extract were used in this experiment:
Dilution 1:200 ml of SCG-HT in 30 L of water;
Dilution 2:300 ml of SCG-HT in 30 L of water; and
Dilution 3:400 ml of SCG-HT in 30 L of water.

The treatments were started 6 days after planting. The treatment protocols are summarized in Table 3.

TABLE 3
Field Test - Plant treatment protocols

| Week | P1 | P2 |
|---|---|---|
| Treatment week 1 | Single pulse of Dilution 1 | Double pulse of Dilution 1 |
| Treatment week 2 | Single pulse of Dilution 1 | Double pulse of Dilution 1 |
| Treatment week 3 | Single pulse of Dilution 1 | Double pulse of Dilution 1 |
| Treatment week 4 | Single pulse of Dilution 1 | Double pulse of Dilution 1 |
| Treatment week 5 | None* | Double pulse of Dilution 1 |
| Treatment week 6 | Single pulse of Dilution 2 | Double pulse of Dilution 2 |
| Treatment week 7 | None | Double pulse of Dilution 2 |
| Treatment week 8 | Single pulse of Dilution 2 | Double pulse of Dilution 2 |
| Treatment week 9 | None | Double pulse of Dilution 2 |
| Treatment week 10 | Single pulse of Dilution 3 | Double pulse of Dilution 3 |
| Treatment week 11 | None | Double pulse of Dilution 3 |
| Treatment week 12 | Single pulse of Dilution 3 | Double pulse of Dilution 3 |
| Total: | 8 treatments; 2 L of coffee | 24 treatments; 7 L of coffee |
| | extract** | extract** |

*None signifies no treatment
**Calculated on undiluted basis

The effects of the extracts were evaluated at four different time points, specifically 40, 75, and 125 days after planting, as well as at the point of harvest.

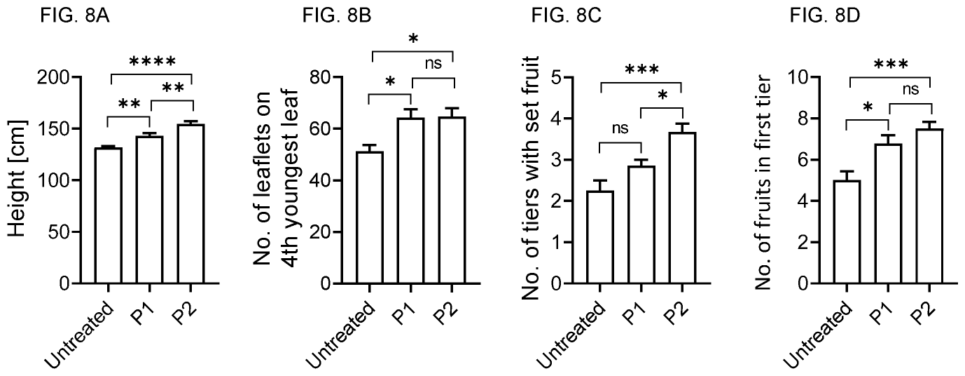

As shown in FIG. 8A-FIG. 8F, no toxic effect of SCG-HT extracts administered to plant was observed 40 days after planting. Furthermore, a positive impact on growth and potential yield expressed as plant height (FIG. 8A), number of leaflets on 4^{th} youngest leaf (FIG. 8B) number of tiers with set fruit (FIG. 8C), and number of fruits in first tier (FIG. 8D) was observed for both treatment regimes in a comparison to untreated control. Asterisks represent statistical significance in Welch's t-test (*p-value<0.05; **p-value<0.01; ***p-value<0.001).

As used herein, the term tier is intended to mean a group of flowers or fruits that emerge from the same point or level along the stem of a tomato plant. Each tier typically produces several fruits, and tomato plants can have multiple tiers or clusters of fruit at different heights along the stem.

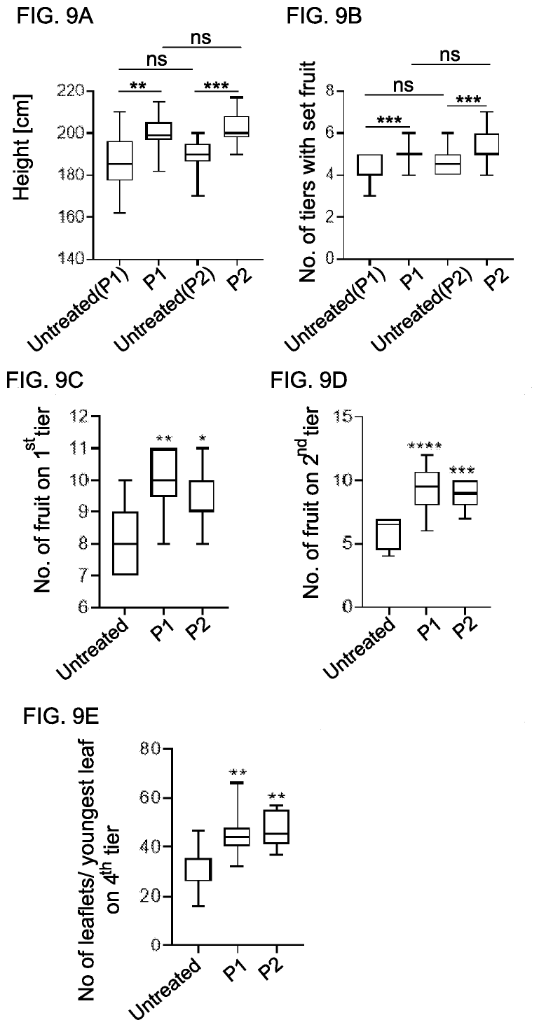

Similarly, no toxic effect of SCG-HT extracts administered to plant was observed 75 days after planting (FIG. 9A-FIG. 9E). Moreover, a positive impact on growth and potential yield expressed as plant height (FIG. 9A), number tiers with set fruit (FIG. 9B), number of fruits on first tier (FIG. 9C), number of fruits on second tier (FIG. 9D), and number of leaflets per youngest leaf on fourth tier (FIG. 9E) was observed for both treatment regimes in a comparison to untreated control. Asterisks represent statistical significance in Welch's t-test (*p-value<0.05; **p-value<0.01; ***p-value<0.001; ****p-value<0.0001).

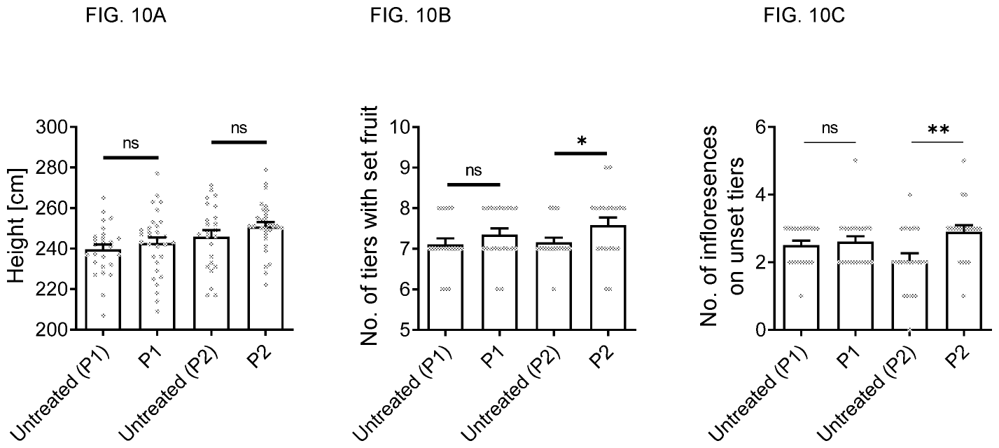

Also, 125 days after planting no toxic effect of SCG-HT extracts administered to plant was observed (FIG. 10A-FIG. 10C). No negative influence was observed on plant height (FIG. 10A). Additionally a positive impact on growth and potential yield expressed as number tiers with set fruit (FIG. 10B) and number of inflorescences on unset tiers (FIG. 10C) was observed for treatment regime P2 in a comparison to untreated control. Asterisks represent statistical significance in Welch's t-test (*p-value<0.05; **p-value<0.01). All experimental values are shown (dots).

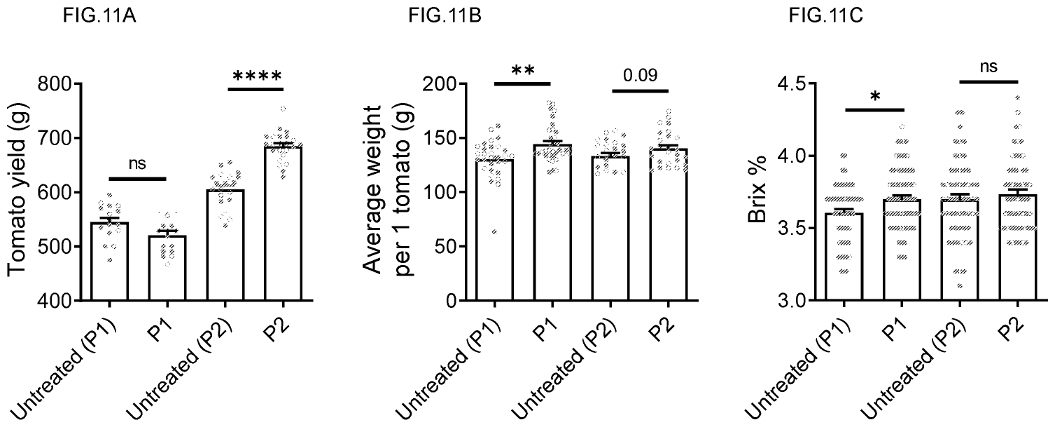

In a good agreement with the above-described measurements, the harvesting results presented in FIG. 11A-FIG. 11C shown no negative effect of SCG-HT extracts administered to plant. Furthermore, positive impact on tomato yield (FIG. 11A) was observed for treatment regime P2 in a comparison to untreated control, positive impact on average weight per one tomato (FIG. 11B) was observed for both treatment regimes in comparison to their respective untreated controls, and positive impact on the amount of soluble sugars per tomato, expressed as Brix % (FIG. 11C) was observed for treatment regime P1 in a comparison to untreated control. Asterisks represent statistical significance in Welch's t-test (*p-value<0.05; **p-value<0.01X; ***p-value<0.001). All experimental values are shown (dots).

### Example 6: The Oxidative Burst and Increased Ethylene Production in Plants Following the Treatment with SCG-HT Extract, and Ability of SCG-HT to Elicit Defense

Increased production of reactive oxygen species (ROS) and ethylene (C₂H₄) is associated with the activation of plant innate immune responses. Therefore, biostimulant activity of SCG-HT extract was assessed, along with the ability to induce a heightened plant immune response.

ROS and ethylene (C₂H₄) production measurements were performed as previously described by Leibman-Markus et al. (Plant pattern recognition receptors: Methods and protocols, 167-172 (2017)) incorporated herein by reference.

To measure ROS levels, leaf disks with a diameter of 0.5 cm were taken from the 4th to 6th leaves of 5 to 6-week-old tomato plants that had been pre-treated with either a mock solution or an SCG-HT extract (dilution 1:100). Disks were floated in a white 96-well plate (SPL Life Sciences, Korea) containing 250 μL distilled water for 4-6 h at room temperature. Following incubation, the water was removed, and a ROS measurement reaction solution was added. This solution contained 1 μg/mL of Ethylene Inducing Xylanase (EIX), which had been purified according to the method described by Anand et al. (International Journal of Molecular Sciences, 22(8), 4214 (2021)) incorporated herein by reference. Light emission was immediately measured using a luminometer (GloMax® Discover, Promega, USA).

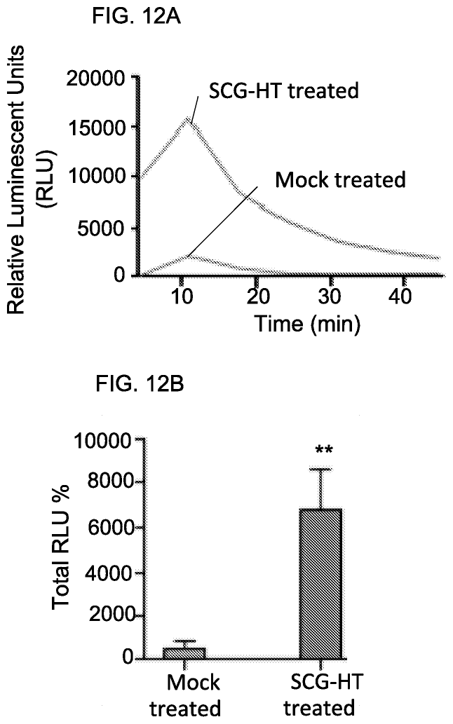

As shown in FIG. 12A-FIG. 12B, pretreatment with an SCG-HT extract significantly increased the response to elicitation with EIX. The increased response was evident in both representative kinetic experiment (FIG. 12A) and when results of several experiments were averaged (FIG. 12B). Notably, in FIG. 12B the ROS production of Mock-treated plant is considered to be 100%. The great difference between the Mock-treatment and the SCG-HT extract pretreatment is clearly evidenced from these results.

Two models of ethylene production were studied: (i) wounding-induced ethylene production and (ii) elicitor-induced ethylene production. In both models leaf disks 0.9 cm in diameter were taken from leaves 4-6 of 5-6-week-old Mock treated or SCG-HT extract treated plants (i.e. pretreated with SCG-HT extract diluted 1:100). Disks were washed in water for 1-2 h.

In wounding-induced model six disks from mock-treated plants and six discs from SCG-HT extract treated plants were wounded and sealed in a 10 mL flasks containing 1 mL assay medium for 6 hours at room temperature.

In elicitor-induced model six disks from mock-treated plants and six discs from SCG-treated plants were sealed in a 10 mL flasks containing 1 mL assay medium (containing 1 μg/mL EIX) for 6 h at room temperature.

Ethylene production was measured by gas chromatography (Varian 3350, Varian, California, USA).

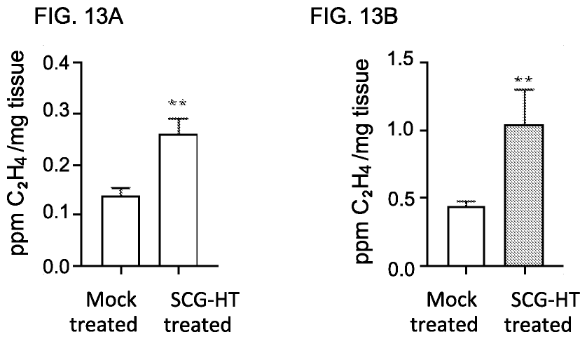

As shown in FIG. 13A-FIG. 13B, pretreatment with SCG-HT extract increased ethylene production in both wounding-induced ethylene production model (FIG. 13A) and elicitor-induced ethylene production model (FIG. 13B). Asterisks represent statistical significance in Welch's t-test (**p-value<0.01).

### Example 7: Comparison Between SCG-HT Extract and a Conventional Coffee Product

To emphasize the unique properties of SCG-HT extract, a comparison was made between the SCG-HT extract prepared according to Example 1 and a SCG extract prepared in a conventional espresso machine (i.e., a secondary extraction in hot water at atmospheric pressure). Total antioxidant capacity analyzed by the FRAP method demonstrated the difference between the extraction procedures. Table 5 provides total antioxidant capacity of the SGT-HT extracts (175-275° C.) compared to the secondary extraction in hot water (SGT-HO). All values are (mg Fe(II) Eq./L).

TABLE 5
Total antioxidant capacity

| | SGT-HT | | | | |
|---|---|---|---|---|---|
| SGT-HO | 175° C. | 200° C. | 225° C. | 250° C. | 275° C. |
| 598.0 ± 4.0 | 7,117.3 ± 68.4 | 6,859.5 ± 28.1 | 7,039.3 ± 276.3 | 7,135.3 ± 193.8 | 6,726.1 ± 91.2 |

1. A method for processing coffee waste, comprising:
subjecting an aqueous mixture comprising particulated coffee waste and an aqueous medium to hydrothermal conditions to obtain a coffee waste slurry comprising particulates;
wherein the hydrothermal conditions comprise a temperature above 170° C. and a pressure of 1 Mpa or greater;
removing at least part of the particulates from said coffee waste slurry to obtain a coffee waste extract product.

2. The method of claim 1, wherein said particulated coffee waste comprises at least one of discarded coffee beans, spent coffee beans or coffee pulp.

3. The method of claim 1, wherein said coffee waste comprises ground coffee waste.

4. The method of claim 1, wherein said aqueous medium is water.

5. The method of claim 1, wherein said hydrothermal conditions comprise heating to a temperature above 170° C.

6. The method of claim 1, wherein said hydrothermal conditions comprise heating to a temperature of 170° C. to 325° C.

7. (canceled)

8. The method of claim 5, wherein said pressure comprises 1 Mpa to 10 MPa.

9. The method of claim 1, wherein said hydrothermal conditions are within a hydrolyzer.

10. The method of claim 1, wherein said aqueous mixture comprises a solid to liquid ratio (SLR) between said particulated coffee waste and said aqueous medium of at least about 1:3.

11. The method of claim 10, wherein said SLR is from 1:20 to 1:3.

12. (canceled)

13. The method of claim 1, comprising subjecting the coffee waste extract product to demulsification.

14. (canceled)

15. (canceled)

16. A coffee waste extract product comprising:
an aqueous sample volume of 1 liter; and
at least one of:
a total antioxidant capacity of 6000 mg to 8000 mg Fe(II) eq;
a total phenolic content of 2000 mg to 3000 mg galic acid (GA) eq; or
a total furfural compounds content of 1000 ppm to 2000 ppm.

17. The coffee waste extract product of claim 16, wherein at least one of:
the total antioxidant capacity is determined by ferric reducing antioxidant power assay;
the total phenolic content is determined using gallic acid equivalence method; or
the total furfural compounds content is determined by gas chromatography.

18. (canceled)

19. (canceled)

20. The coffee waste extract product of claim 16, wherein said furfural compounds comprise any member of the group consisting of furfural, hydroxymethylfurfural and 5-methylfurfural.

21. The coffee waste extract product of claim 16, comprising total dissolved solids in an amount of 20 mg/liter to 60 mg/liter.

22. The coffee waste extract product of claim 16, comprising potassium content of 200 mg/liter to 400 mg/liter.

23. (canceled)

24. (canceled)

25. (canceled)

26. An agricultural method comprising:
applying to a plant or a plant soil an amount of a coffee waste extract product according to claim 16, the amount being effective to provide improvement in at least one parameter associated with plant growth, said improvement being in comparison to the at least one parameter determined in an absence of said coffee waste extract product.

27. The agricultural method of claim 26, wherein said coffee waste extract product is a liquid product.

28. (canceled)

29. The agricultural method of claim 26, wherein said coffee waste extract product is particulated coffee waste extract product.

30. (canceled)

31. The agricultural method of claim 26, wherein said at least one parameter is selected from the group consisting of microbial load, pest infestation level, plant yield, plant biomass, plant height, plant part complexity, plant part dimensions, number of plant parts, number of tiers with set fruit, number of fruits in a specific tier, number of leaflets on a set youngest leaf, number of inflorescences on unset tiers, amount of soluble sugars per plant (expressed as Brix %) and any combination thereof.

32. (canceled)
